(19) United States
(12) Patent Application Publication
(10) Pub. No.: US 2004/0185734 A1
(43) Pub. Date: Sep. 23, 2004

(54) Reinforced fabric substrate and method for making the same

(76) Inventors: Hugh Douglas Gray, Laurens, SC (US); Carly Peterson Tebbetts, Greenville, SC (US)

Correspondence Address: Thomas L. Moses, Legal Department, M-495, PO Box 1926, Spartanburg, SC, 29304, US

(21) Appl. No.: 10/394,616

(22) Filed: Mar. 21, 2003

(51) Int. Cl. D04B 21/00; D04H 1/74; D04H 3/04; B32B 27/04

(52) U.S. Cl. 442/312; 442/304; 442/313; 442/366; 442/50; 442/58; 428/192

(57) ABSTRACT

A fabric substrate for use in reinforcing laminated and coated fabrics. The fabric substrate of the present invention is particularly useful for reinforcing areas along the resulting coated or laminated fabric that may experience local areas of tensile forces, such as areas of attachment. To address these local areas, the fabric substrate includes reinforced weft portions in spaced groups to provide strengthened areas for fastening or attachment of the resulting coated fabric.

### BACKGROUND OF THE INVENTION

The present invention relates generally to reinforcing fabric substrates, and, more particularly, to a new and improved reinforcing fabric substrate for use in increasing the tensile strength of laminated and coated fabrics.

Layers of fabric are frequently laminated or otherwise joined together to produce fabrics having desirable characteristics not fully exhibited by the layers individually. Among other characteristics produced, laminating fabrics results in higher tensile strength within the plane of the fabrics. However, the tensile strength of these fabrics is oftentimes diminished in areas of the fabric that may experience higher, local tensile forces. For example, in a fabric having fasteners such as grommets, the area surrounding the fasteners may experience an increase in tensile force when a force is applied to the grommet. Therefore, these areas are more likely to tear and/or rot during the particular application of the fabric.

In the industrial and commercial roofing area, it is especially desirable to have a thin, flexible material which can be easily rolled out and tacked down and which will exhibit exceptional tensile strength, thereby providing protection for a number of years without problem. Because various states and organizations have enacted building code provisions that the roofing material must meet or exceed before it can be used for industrial roofs, these membranes share common features that comply with these codes. Existing roofing membranes typically include PVC (polyvinyl chloride), TPO (thermoplastic olefin), and EPDM (ethylene propylene diene monomer) with scrim reinforcement. Woven, weft insertion knit, and laid scrim fabrics have been traditionally used for fabric reinforcement. The fabric disclosed and claimed herein also conforms to the necessary codes of the various organizations and states.

Heretofore, it has been difficult to produce an industrial roofing membrane that was thin and flexible enough to facilitate transport and installation, durable enough to withstand severe weather conditions for an extended period of time, and strong enough to remain securely fastened to the roof under severe adverse wind and rain conditions.

Prior attempts to produce such an industrial roofing membrane have met with some success. U.S. Pat. Nos. 5,540,971 and 5,525,413, both disclose a triaxially wound non woven roofing membrane fabric, where the selvage areas of the fabric have an increased number of warp yarns in spaced groups to provide an area for the attachment of the fabric to a roof through the use of roofing tacks inserted through the selvage areas of the fabric. The roofing membrane fabric produced in accordance with those patents perform better than previous attempts; however, it may not perform as well as may be desired in high wind situations. In other fabric formation technologies, particularly weft insertion warp knitting and weaving, the cross direction weft ends of those products are cut to size, so that the weft yarns are non continuous throughout the fabric.

All patents referenced herein are incorporated by reference in their entirety.

Accordingly, there remains a need for an improved fabric substrate for use in reinforcing laminated and coated fabrics, such as roofing membranes, that is durable and exhibits superior tensile strength characteristics.

### SUMMARY OF THE INVENTION

According to its major aspects and briefly recited, the present invention is an improved and novel fabric substrate for use in reinforcing laminated and coated fabrics. As used herein, the term “substrate” signifies fabric to which coatings or other fabrics are applied. In particular, the fabric substrate of the present invention is useful for reinforcing areas in the cross machine direction that experience local areas of tensile forces at the attachment points. To address these local areas, the fabric substrate includes reinforced weft portions in spaced groups to provide strengthened areas for fastening or attachment of the resulting coated fabric.

In a first embodiment, the fabric substrate is made by a weft insertion method. In a weft insertion method, the warp and weft yarns are tied or knitted together by a third yarn. Accordingly, the fabric substrate has plural lateral weft yarns that cross plural longitudinal warp yarns, and plural knitting yarns that tie the weft and warp yarns together at their intersections. In the areas along the fabric that will experience the greatest local tensile forces, such as the areas of attachment, there exist an increased number of weft yarns compared to the adjacent areas along the fabric. This fabric substrate can thereafter be laminated or coated by a variety of materials such as EPDM, PVC, TPO, CSPE or a modified bitumen, depending on its intended use.

In a second embodiment, a bidirectional, non-woven fabric substrate is provided including a plurality of lateral weft yarns that intersect a plurality of warp yarns at right angles and that are bonded at the intersections by an adhesive composition. As with the first embodiment, the fabric substrate includes an increased number of weft yarns at particular intervals along the fabric as compared to adjacent areas of weft yarns.

In a third embodiment, the fabric substrate includes a tri-directional, also commonly referred to as triaxial, non-woven scrim fabric that is held together by an adhesive composition. As used herein, the term “scrim” shall mean a fabric having an open construction used as a base fabric or a reinforcing fabric. In a triaxial scrim, plural weft yarns having both an upward diagonal slope and a downward diagonal slope are located between plural longitudinal warp yarns that are located on top of the weft yarns and below the weft yarns. In certain intervals along the fabric, there are more weft yarns having both an upward diagonal slope and a downward diagonal slope as compared to adjacent areas having weft yarns along the fabric.

A feature of the present invention is the use of a fabric substrate having a reinforced weft portions in the areas that may be exposed to higher local tensile forces, such as areas of attachment or fastening. By providing an increase in weft yarns along particular intervals along the fabric, these areas become strengthened and there is less of a likelihood that the fabric will tear, become unsecured, or disintegrate during severe weather and high winds. Further, because only areas experiencing higher local tensile forces include reinforcement, the fabric substrate remains relatively lightweight, thereby contributing the overall lightweight feature of the resulting laminated or coated fabric.

Another feature of the present invention is the use of a lightweight fabric substrate having reinforced weft portions in combination with a polymer coating such as EPDM, PVC, TPO, CSPE or a modified bitumen. This combination results in a flexible, lightweight, and strong alternative to prior sheet materials, such as roofing membranes. Further, this fabric is economical to manufacture, and overcomes some of the problems commonly associated with coated or laminated fabrics.

Other features and advantages of the present invention will be apparent to those skilled in the art from a careful reading of the Detailed Description of the Preferred Embodiment presented below and accompanied by the drawings.

### BRIEF DESCRIPTION OF THE DRAWINGS

In the drawings,

FIG. 1 is a top view of a fabric substrate used to reinforce coated and laminated fabrics according to a preferred embodiment of the present invention;

FIG. 2 is a top detailed view of the fabric substrate according to a preferred embodiment of the present invention;

FIG. 3, is a cross-sectional view of the fabric substrate in combination with a polymeric material, which forms a roofing membrane according to a preferred embodiment of the present invention;

FIG. 4, is a top view of a fabric substrate used to reinforce coated and laminated fabrics according to a first alternative embodiment of the present invention;

FIG. 5 is a top detailed view of a fabric substrate used to reinforce coated and laminated fabrics according to a first alternative embodiment of the present invention; and

FIG. 6 is a top view of a fabric substrate used to reinforce coated and laminated fabrics according to a second alternative embodiment of the present invention.

### DETAILED DESCRIPTION OF THE PREFERRED EMBODIMENTS

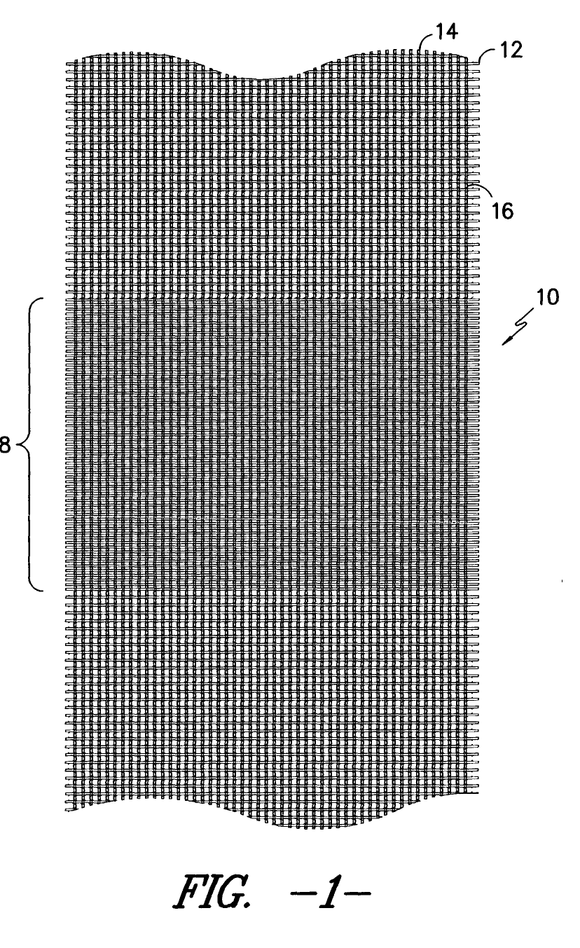

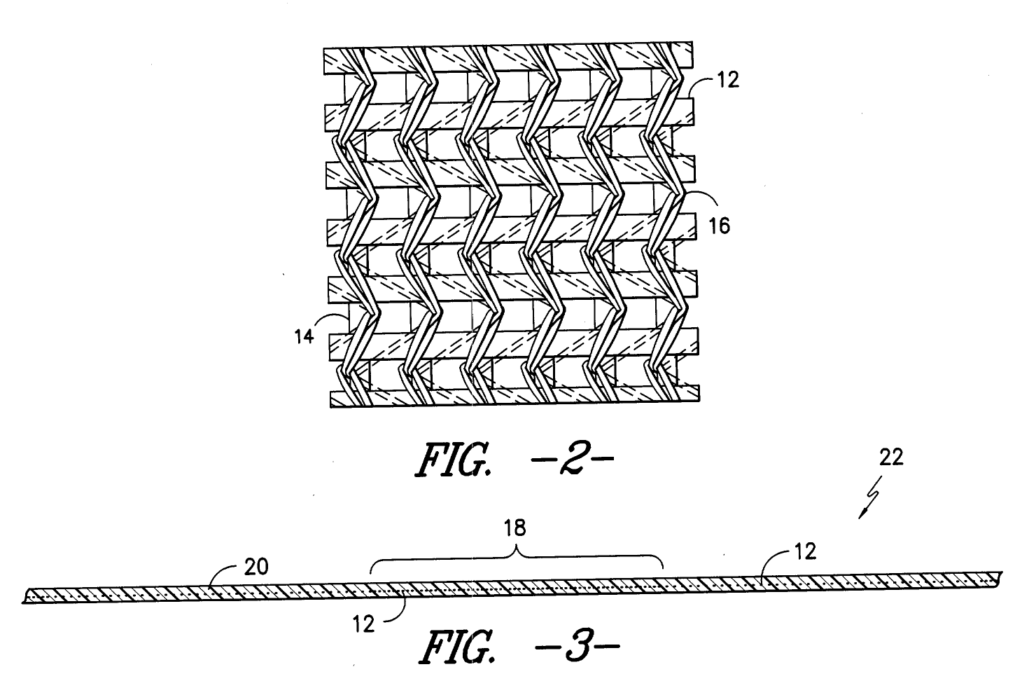

The present invention is a new and improved fabric reinforcement substrate 10 to which coatings and/or laminates can be applied. In a first embodiment that is illustrated in FIG. 1, fabric substrate 10 is made by a weft-insertion method. In weft-insertion, warp yarns are inserted under the weft yarns, and a third type of yarn, a knitting yarn, locks the warp and weft yarns together in a chain stitch. Accordingly, fabric substrate 10 includes plural lateral weft yarns 12 and plural longitudinal warp yarns 14 that are inserted under the weft yarns 12, and plural knitting yarns 16 that tie or bind the weft 12 and warp yarns 14 together at their intersections. These yarns and their relation to each other are shown in detail in FIG. 2. As further shown in FIG. 1, fabric substrate 10 includes a reinforced weft area 18. In this reinforced area 18, there are a greater number of weft yarns 12 than are located in adjacent areas along fabric substrate 10. Preferably, reinforced weft area 18 is included every 6 to 18 inches along fabric substrate 10. However, other ranges are contemplated. Depending on how many areas along the resulting fabric that may experience local tensile forces, such as areas of fastener penetration, and their locations, reinforced weft area 18 is included in each of these areas and in their general locations.

As discussed, a feature of the present invention is the use of reinforced weft areas 18. By providing an increase in the number of weft yarns 12 disposed at particular intervals along the fabric, these areas become strengthened and there is less of a likelihood that the fabric will tear, become unsecured, or disintegrate at the fastening points during severe weather and high winds. Further, because only areas that may be exposed to higher local tensile forces include reinforcement, the fabric substrate remains relatively lightweight, as well as inexpensive to manufacture.

In the preferred configuration of the fabric substrate 10, the adjacent areas to the reinforced weft area 18, includes warp yarns 14 disposed at approximately 6 to 18 ends per inch and weft yarns 12 disposed at approximately 3 to 18 ends per inch. In the reinforced weft area 18, the warp yarns 14 will preferably be disposed at approximately 6 to 18 ends per inch and the weft yarns 12 will be disposed at approximately 6 to 24 ends per inch. However, in whatever combination of warp yarn ends to weft yarn ends that is employed, the reinforced weft area 18 always includes a greater number of weft yarns 12 as compared to the adjacent areas. Warp yarns 14 and weft yarns 12 of this construction are preferably high tenacity polyester yarns having a denier in the range of 150 to 2000. The knitting yarns 16 are also polyester yarns having a denier range of 40 to 150. Depending on the particular intended use of the fabric, however, it is contemplated that weft yarns, warp yarns, and knitting yarns may also be made of any of the following materials, or combinations thereof: aramid, glass, polyamides, polyolefin, ceramic, and basalt. Other suitable materials may be used, as well.

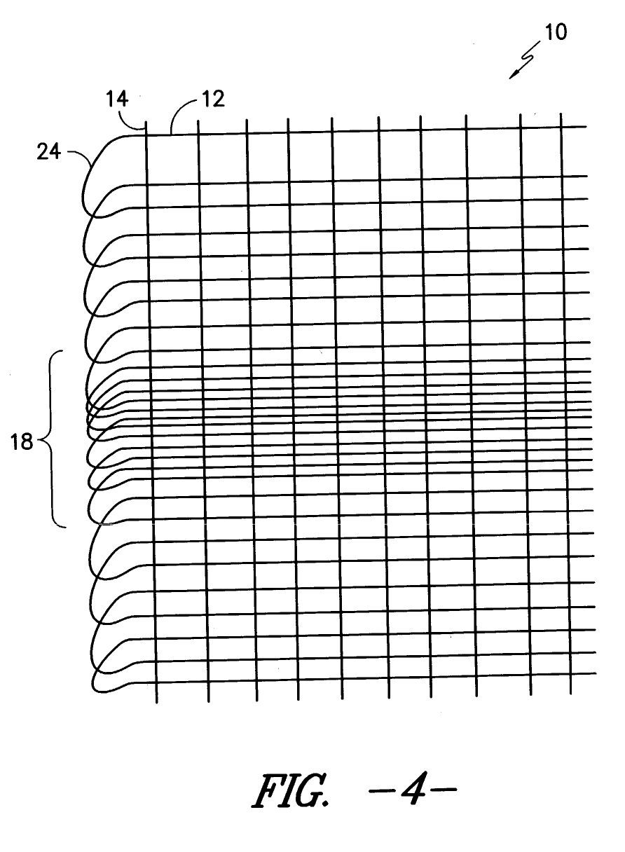

As previously discussed, fabric substrate 10 can be integrated with a variety of laminations or coatings, such as EPDM, PVC, TPO, CSPE or a modified bitumen, depending on the intended use of the resulting fabric. FIG. 3 shows fabric substrate 10 encapsulated with a polymeric material 20 such as ethylene propylene diene monomer (EPDM), polyvinyl chloride (PVC), or thermoplastic olefin (TPO), chlorinated sulfonated polyethylene (CSPE), or a combination of these materials, to form a roofing membrane 22. Optionally, the roofing membrane may be marked to identify the sections of the membrane having reinforced sections, so that roofers may know where to place the attachment means.

Although such a combination is particularly useful as a roofing membrane, the use of other materials are contemplated for the formation of other coated or laminated fabrics. For example, fabric substrate 10 of the present invention may be incorporated into tarps, boat covers, sails, awnings, tents, etc. Basically, any fabric that is coated and/or laminated and that requires additional strength in the areas experiencing local tensile forces, such as areas of mechanical attachments, including grommets, screws, and nails, can be reinforced by the fabric substrate 10. As illustrated, the overall weft ends per inch within the reinforced weft area 18 of the roofing membrane 22 equal roughly 1.5 to 3 times the weft yarn ends in the adjacent areas, although even more weft ends per inch may be used for additional strength, if desired. Regardless of the actual ratio of weft yarn ends in reinforcement area 18 to weft yarn ends in adjacent areas, the reinforced weft area 18 has the largest number of yarns therein because it is the area of impact when the fabric is attached to a roof by a fastening means. Because a greater number of yarns will be secured under a fastening means, such as a tack or screw, increased strength is provided in this area to provide a more stable securement.

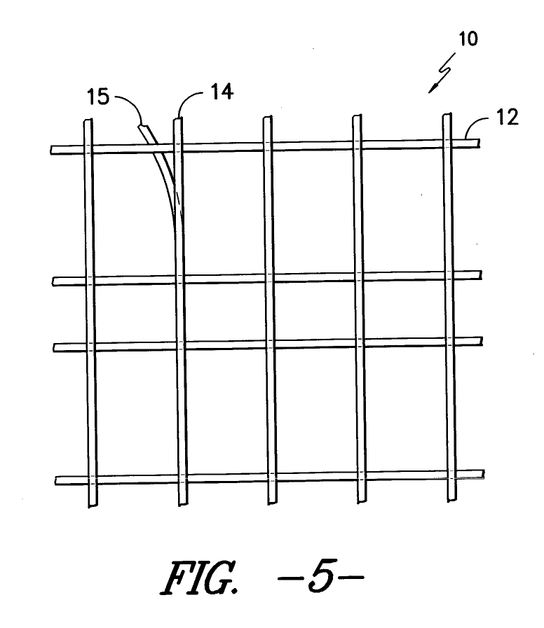

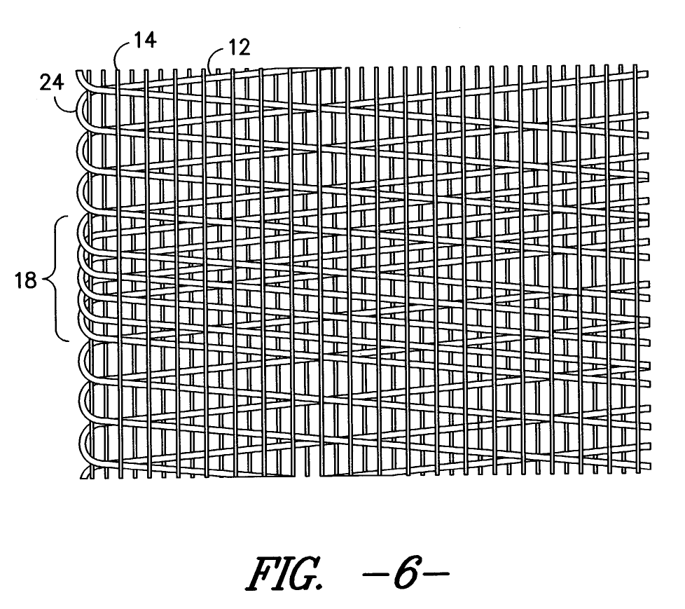

In a second embodiment illustrated in FIGS. 4 and 5, fabric substrate 10 is a bidirectional, non-woven scrim made from continuous yarns, which is held together by an adhesive. As used herein, the term “scrim” shall mean a non-woven fabric having an open construction used as a base fabric or a reinforcing fabric. Also, as used herein, the term “continuous yarn” shall mean a yarn that is uncut, or which is unsegmented. The term “continuous yarn” should not be confused with a continuous filament yarn, which comprises continuous filaments as opposed to staple fibers or tow fibers.

As shown in FIGS. 4 and 5, fabric substrate 10 of second embodiment includes a layer of parallel weft yarns 12 that are disposed between two convergent layers of parallel warp yarns 14, 15. These yarns are held together by an adhesive, such as polyvinyl alcohol (PVOH), acrylic, polyvinyl acetate, polyvinyl chloride, polyvinylidiene chloride, polyacrylate, acrylic latex or styrene butadiene rubber (SBR), plastisol, or any other suitable adhesive.

Fabric substrate 10 is heat set using temperatures from 290° F. to 375° F. This temperature range is used to cure the adhesive used in making the fabric. During the cure of the adhesive, the fabric becomes more stabilized from processing temperature, thus reducing the shrinkage that can occur during subsequent coating or lamination processes.

Similar to the first embodiment, fabric substrate 10 of the second embodiment also includes an area 18 of reinforced weft yarns. In this reinforced area 18, there are a greater number of weft yarns 12 than are located in adjacent areas along fabric substrate 10. Preferably, reinforced weft area 18 is included every 6 to 18 inches along fabric substrate 10. However, other ranges are contemplated dependant on the attachment spacing. Depending on how many areas along the resulting fabric that may experience local tensile forces, such as areas of penetration, and the location of these areas along the fabric, reinforced weft area 18 is included in the general location of the penetration.

However, in the second embodiment, the weft yarns 12 are continuous and are not cut along the edges of the fabric substrate 10 as in the first embodiment. Therefore, weft yarns 12 form loops 24 along the edge portions of fabric substrate 10. This feature contributes to the stability and strength of the resulting fabric, because it is less likely that a fabric having loops along its edges will tear away from a fastening device as compared to a fabric having cut edges. Therefore, the fabric will remain secured to its place of attachment in significantly higher winds and inclement weather.

In the preferred configuration of the fabric substrate 10, the adjacent areas to the reinforced weft area 18, include warp yarns 14, 15 disposed at approximately 4 to 18 ends per inch and weft yarns 12 disposed at approximately 4 to 18 ends per inch. In the reinforced weft area 18, the warp yarns 14, 15 will preferably be disposed at approximately 4 to 18 ends per inch and the weft yarns 12 will be disposed at approximately 6 to 24 ends per inch. As previously described, in whatever combination of warp yarn ends to weft yarn ends that is employed, the reinforced weft area 18 always includes a greater number of weft yarns 12 as compared to the adjacent areas. Although in FIG. 4, it is shown that the overall weft ends per inch within the reinforced weft area 18 equal approximately 1.5 to 3 times the weft yarn ends in the adjacent areas, even more weft ends per inch may be used for additional strength, if desired. Preferably, both weft yarns 12 and warp yarns 14, 15 are made of high tenacity polyester having a denier ranging from 150 to 2000. However, depending on the particular intended use of the fabric, it is contemplated that weft yarns 12 and warp yarns 14, 15 may also be made of any of the following materials, or combinations thereof: aramid, glass, polyamides, polyolefin, ceramic, and basalt.

As with the fabric substrate 10 of the first embodiment, fabric substrate 10 of second embodiment can also be integrated with a variety of laminations or coatings, such as EPDM, PVC, TPO, CSPE or a modified bitumen, to produce a reinforced fabric for the desired application.

A third embodiment of fabric substrate 10 is shown in FIG. 6. As illustrated, fabric substrate 10 is a tri-directional, or triaxial non-woven scrim fabric that is held together by an adhesive composition, such as polyvinyl alcohol (PVOH), acrylic, polyvinyl acetate, polyvinyl chloride, polyvinylidiene chloride, polyacrylate, acrylic latex or styrene butadiene rubber (SBR), plastisol, or any other suitable adhesive. In a triaxial construction, plural weft yarns 12 having both an upward diagonal slope and a downward diagonal slope are located between plural longitudinal warp yarns 14 that are located on top of the weft yarns 12 and below the weft yarns 12. As with second embodiment, fabric substrate 10 of third embodiment is heat set using temperatures from 290° F. to 375° F. Fabric substrate 10 also includes a reinforced weft area 18. In this reinforced area 18, there are a greater number of weft yarns 12 than are located in adjacent areas along fabric substrate 10. Preferably, reinforced weft area 18 is included every 6 to 18 inches along fabric substrate 10. However, other ranges are contemplated. Depending on how many areas along the resulting fabric that may experience local tensile forces, such as areas of penetration, and the location of these areas along the fabric, reinforced weft area 18 is included in the general location of the penetration. Further, the weft yarns 12 are continuous and are not cut along the edges of the fabric substrate 10. Therefore, weft yarns 12 form loops 24 along the edge portions of fabric substrate 10. As with the second embodiment, this feature contributes to the stability and strength of the resulting fabric, because it is less likely that a fabric having loops along its edges will tear away from a fastening device.

In the preferred construction of fabric substrate, weft yarns 12 and warp yarns 14 are made of high-tenacity polyester and have a denier from 150 to 2000. However, depending on the particular intended use of the fabric, it is contemplated that weft yarns 12 and warp yarns 14 may also be made of any of the following materials, or combinations thereof: aramid, glass, polyamides, polyolefin, ceramic, and basalt. The preferred range of the fabric construction of the adjacent areas to the areas of reinforced weft 18 is between about 4×2×2 (4 ends/inch in the warp direction and 2 ends per inch on the upward diagonal slope in the weft direction, and 2 ends/inch on the downward diagonal slope in the weft direction) and 18×9×9, and is most preferably 8×3×3. In the reinforced weft area 18, the preferred range of fabric construction is between approximately 4×3×3 and 18×12×12, and is most preferably 8×4.5×4.5. However, in whatever combination of warp yarn ends to weft yarn ends that is employed, the reinforced weft area 18 always includes a greater number of weft yarns 12 as compared to the adjacent areas. Although FIG. 6 shows that the overall weft ends per inch within the reinforced weft area 18 equals approximately 1.5 to 3 times the weft yarn ends in the adjacent areas, even more weft ends per inch may be used for additional strength, if desired.

Finally, the fabric substrate 10 of the third embodiment can also be integrated with a variety of laminations or coatings, such as EPDM, PVC, TPO, CSPE or a modified bitumen, to produce a reinforced fabric for a desired application as with the first and second embodiments.

Those skilled in the art of reinforcement fabrics will recognize that many substitutions and modifications can be made in the foregoing preferred embodiments without departing from the spirit and scope of the present invention.

What is claimed is:

1. A reinforcement fabric, said fabric comprising:
plural weft yarns that are tied to plural warp yarns by plural knitting yarns to form a substrate, said substrate having at least one area that is reinforced with additional weft yarns.

2. The fabric as recited in claim 1, wherein said weft yarns, said warp yarns and said knitting yarns are selected from the group consisting of aramid, glass, polyester, polyamides, polyolefins, ceramics, basalts, and any combination thereof.

3. The fabric as recited in claim 1, wherein said weft yarns are disposed at approximately 3 to 18 ends per inch outside of said reinforced area.

4. The fabric as recited in claim 1, wherein said weft yarns are disposed at approximately 6 to 24 ends per inch within said reinforced area.

5. The fabric as recited in claim 1, wherein said warp yarns are disposed at approximately 6 to 18 ends per inch.

6. The fabric as recited in claim 1, wherein said weft yarns and said warp yarns have a denier range from approximately 150 to 2000 denier.

7. The fabric as recited in claim 1, wherein said knitting yarns have a denier range from approximately 40 to 150 denier.

8. The fabric as recited in claim 1, wherein said reinforced area is included every 6 to 18 inches along the length of said fabric substrate.

9. A reinforcement fabric, said fabric comprising:
plural weft yarns and plural warp yarns that are bonded together by an adhesive to form a substrate, said substrate having at least one area that is reinforced with additional weft yarns.

10. The fabric as recited in claim 9, wherein said adhesive is selected from a group consisting of polyvinyl alcohol, polyvinyl acetate, styrene butadiene rubber, polyvinyl chloride, polyvinylidene chloride, plastisol, polyacrylate, acrylic latex, and any combinations thereof.

11. The fabric as recited in claim 9, wherein said weft yarns and said warp yarns are selected from the group consisting of aramid, glass, polyester, polyamides, polyolefins, ceramics, basalts, and any combination thereof.

12. The fabric as recited in claim 9, wherein said weft yarns are continuous yarns that form loops along the edges of said fabric substrate.

13. The fabric as recited in claim 9, wherein said fabric substrate is a bi-directional non-woven scrim.

14. The fabric as recited in claim 13, wherein said weft yarns are disposed at approximately 4 to 18 ends per inch outside of said reinforced area.

15. The fabric as recited in claim 13, wherein said weft yarns are disposed at approximately 6 to 24 ends per inch within said reinforced area.

16. The fabric as recited in claim 13, wherein said warp yarns are disposed at approximately 4 to 18 ends per inch.

17. The fabric as recited in claim 9, wherein said fabric substrate is a tri-directional non-woven scrim.

18. The fabric as recited in claim 17, wherein said fabric substrate has a fabric construction of 4 to 18 ends per inch in the warp direction and 2×2 to 9×9 ends per inch in the weft direction in outside of said reinforced area.

19. The fabric as recited in claim 17, wherein said fabric substrate has a fabric construction of 4 to 18 ends per inch in the warp direction and 3×3 to 12×12 ends per inch in the weft direction in said reinforced area.

20. The fabric as recited in claim 9, wherein said reinforced area is included every 6 to 18 inches along the length of said fabric substrate.

21. A composite roofing membrane, comprising:
a fabric comprising plural weft yarns and plural warp yarns that are connected to form a substrate, said substrate having an area that is reinforced with additional weft yarns; and
a polymeric material encapsulating said fabric.

22. The roofing membrane as recited in claim 21, wherein said polymeric material is selected from the group consisting of EPDM, TPO, PVC, modified bitumen, chlorinated sulfonated polyethylene, and any combinations thereof.

23. The roofing membrane as recited in claim 21, wherein said weft yarns and said warp yarns area selected from the group consisting of aramid, glass, polyester, polyamides, polyolefins, ceramics, basalts, and any combination thereof.

24. The roofing membrane as recited in claim 21, wherein said weft yarns and said warp yarns are connected by plural knitting yarns.

25. The roofing membrane as recited in claim 21, wherein said weft yarns and said warp yarns are connected by an adhesive.

26. The roofing membrane as recited in claim 25, wherein said adhesive is selected from the group consisting of polyvinyl alcohol, polyvinyl acetate, styrene butadiene rubber, polyvinyl chloride, polyvinylidene chloride, plastisol, polyacrylate, acrylic latex, and any combinations thereof.

27. The roofing membrane as recited in claim 25, wherein said weft yarns are continuous yarns that form loops along the edges of said fabric substrate.

28. The roofing membrane as recited in claim 25, wherein said fabric substrate is a bi-directional non-woven scrim.

29. The roofing membrane as recited in claim 25, wherein said fabric substrate is tri-directional non-woven scrim.

30. The fabric as recited in claim 21, wherein said reinforced area is included every 6 to 18 inches along the length of said fabric substrate.

31. A method for manufacturing a reinforced fabric, said method comprising:
providing plural weft yarns;
connecting said plural weft yarns with plural warp yarns to form a fabric substrate;
reinforcing an area of said substrate with additional weft yarns; and
coating said fabric substrate.

32. The method as recited in claim 31, wherein said connecting step is performed with plural knitting yarns.

33. The method as recited in claim 31, wherein said connecting step is performed with an adhesive.

34. The method as recited in claim 33, wherein said adhesive is selected from the group consisting of polyvinyl alcohol, polyvinyl acetate, styrene butadiene rubber, polyvinyl chloride, polyvinylidene chloride, plastisol, polyacrylate, acrylic latex, and any combinations thereof.
